(19) United States
(12) Patent Application Publication
(10) Pub. No.: US 2025/0023513 A1
(43) Pub. Date: Jan. 16, 2025

(54) PHOTOVOLTAIC POWER GENERATION DEVICE FOR FACILITATING HEAT DISSIPATION

(71) Applicant: Hebei Qinhuai Data Co., Limited., Zhangjiakou City (CN)

(72) Inventor: Binghua ZHANG, Zhangjiakou City (CN)

(21) Appl. No.: 18/764,305

(22) Filed: Jul. 4, 2024

(30) Foreign Application Priority Data
Jul. 13, 2023 (CN) 202310861263.0

(51) Int. Cl. H02S 40/42

(52) U.S. Cl. CPC H02S 40/42

(57) ABSTRACT

The present disclosure discloses a photovoltaic power generation device for facilitating heat dissipation, including a frame in contact with a photovoltaic panel. The photovoltaic panel is in contact with a pressure block slidably connected to a mounting seat. The mounting seat is slidably connected to the photovoltaic panel, the mounting seat is fixedly connected to the frame, and the frame is fixedly connected to a fixed seat. An interior the fixed seat is slidably connected to a strainer fixedly connected to a pull rod. The strainer is provided with a connecting mechanism, and the photovoltaic panel is provided with a mounting mechanism.

### CROSS REFERENCE TO RELATED APPLICATION

This application claims priority to Chinese Patent Application No. 202310861263.0, titled “PHOTOVOLTAIC POWER GENERATION DEVICE FOR FACILITATING HEAT DISSIPATION” and filed to the China National Intellectual Property Administration on Jul. 13, 2023, the entire contents of which are incorporated herein by reference.

### TECHNICAL FIELD

The present disclosure relates to the field of photovoltaic power generation, and more particularly, to a photovoltaic power generation device for facilitating heat dissipation.

### BACKGROUND

An invention patent with a patent authorization announcement number CN212367222U discloses a photovoltaic power generation device with heat dissipation function, which includes a base. Two sides of the base are fixedly connected to a mounting block, respectively, and the base is internally provided with a first sliding chute, where an upper side of the first sliding chute is provided with a first elongated slot. A side of the base is fixedly connected to a box. An inner wall of the box is fixedly connected to a fixed frame, a motor is fixedly arranged inside the fixed frame, and an output end of the motor passes through the box and the base and is fixedly connected to a threaded rod. An end of the threaded rod far from the motor is slidably connected to an inner wall of the first sliding chute, an outer wall of the threaded rod is sleeved with a plurality of sliders, and an upper side of each of the sliders is fixedly connected to a first U-shaped block. In the photovoltaic power generation device with heat dissipation function provided by the present disclosure, heat-conducting fins can transfer heat generated by photovoltaic panels, radiating fins can dissipate the heat absorbed by the heat-conducting fins, and the heat is dissipated from a plurality of ventilation holes. Dustproof meshes can prevent dusts from entering, making it easier to adjust angles of the photovoltaic panels. Thus the photovoltaic power generation device has higher applicability.

In the existing technologies mentioned above, heat dissipation of the photovoltaic panels may be achieved by means of heat conduction during the use of the power generation device. However, it is not convenient to disassemble the dustproof meshes for dust prevention during use, thus it is not convenient to clean the dustproof meshes when dusts are attached to surfaces of the dustproof meshes, which may adversely affect air ventilation and thus adversely affect heat dissipation effects. Moreover, after installation for use, it is not convenient to disassemble the photovoltaic panels, making it inconvenient for maintenance and repair. Therefore, the existing technologies need to be improved.

### SUMMARY

The present disclosure provides a photovoltaic power generation device for facilitating heat dissipation, to solve problems that dustproof meshes are not conveniently disassembled and cleaned and photovoltaic panels are not conveniently disassembled for maintenance and repair.

According to embodiments of the present disclosure, there is provided a photovoltaic power generation device for facilitating heat dissipation, including a frame in contact with a photovoltaic panel. The photovoltaic panel is in contact with a pressure block slidably connected to a mounting seat. The mounting seat is slidably connected to the photovoltaic panel, the mounting seat is fixedly connected to the frame, and the frame is fixedly connected to a fixed seat. An interior the fixed seat is slidably connected to a strainer fixedly connected to a pull rod. The strainer is provided with a connecting mechanism, and the photovoltaic panel is provided with a mounting mechanism.

In the photovoltaic power generation device for facilitating heat dissipation provided by the present disclosure, the connecting mechanism includes an insertion block, a groove, an insertion rod, a connection block, a sliding rod, a first spring, and a slider. The strainer is fixedly connected to the insertion block, and the insertion block is slidably connected to the fixed seat. An interior of the insertion block is slidably connected to the insertion rod, the insertion rod is slidably connected to the fixed seat, and the insertion rod is fixedly connected to the connection block, which is in contact with the fixed seat. The connection block is fixedly connected to the sliding rod, which is slidably connected to the fixed seat. The first spring is arranged on an outer side of the sliding rod, which is fixedly connected to the slider, and the slider is in contact with the fixed seat. By designing the connecting mechanism, it is convenient to disassemble the strainer.

In the photovoltaic power generation device for facilitating heat dissipation provided by the present disclosure, the fixed seat is provided with a groove, and an interior of the groove is slidably connected to an insertion block. By designing the groove, the insertion block may slide within the groove.

In the photovoltaic power generation device for facilitating heat dissipation provided by the present disclosure, one end of the first spring is fixedly connected to the slider, and other end of the first spring is fixedly connected to the fixed seat. By designing the first spring, a force applied by the first spring may act on the slider.

In the photovoltaic power generation device for facilitating heat dissipation provided by the present disclosure, the mounting mechanism includes a dovetail block, a limit rod, a connecting rod, a fixed rod, a second spring, and a pull block. The pressure block is fixedly connected to the dovetail block, which is slidably connected to the mounting seat. An interior of the dovetail block is slidably connected to the limit rod, which is fixedly connected to the connecting rod. The limit rod and the connecting rod are both slidably connected to the mounting seat, and an interior of the connecting rod is slidably connected to the fixed rod, which is fixedly connected to the mounting seat. An outer side of the fixed rod is provided with the second spring, and the connecting rod is fixedly connected to the pull block, which is slidably connected to the mounting seat. By designing the mounting mechanism, it is convenient to disassemble the photovoltaic panel.

In the photovoltaic power generation device for facilitating heat dissipation provided by the present disclosure, one end of the second spring is fixedly connected to the connecting rod, and other end of the second spring is fixedly connected to the mounting seat. By designing the second spring, the force applied by the second spring may act on the connecting rod.

The technical solutions provided by the embodiments of the present disclosure may include following beneficial effects.

1. By means of the strainer, dusts are filtered during air ventilation and heat dissipation inside the frame, thereby achieving an objective of internal dust prevention. Furthermore, the strainer may be easily disassembled, so the strainer may be easily and quickly disassembled and then cleaned when there are many dust impurities attached to a surface of the strainer, to prevent blockage of the strainer from adversely affecting internal heat dissipation efficiency of the frame.

2. By means of the pressure block, the photovoltaic panel may be pressed down. By means of insertion between the limit rod and the dovetail block, the pressure block may be limited. In this way, the photovoltaic panel is limited and fixed. Furthermore, the pressure block may be easily disassembled, making it convenient for maintenance and repair after the photovoltaic panel is disassembled.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a three-dimensional view of an overall structure according to the present disclosure;

FIG. 2 is a front sectional view of a local structure of a strainer in FIG. 1 according to the present disclosure; and

FIG. 3 is a top sectional view of a local structure of a mounting seat in FIG. 1 according to the present disclosure.

### REFERENCE NUMERALS IN THE ACCOMPANYING DRAWINGS

frame 1; photovoltaic panel 2; pressure block 3; mounting seat 4; fixed seat 5; strainer 6; pull rod 7; connecting mechanism 8; mounting mechanism 9; insertion block 81; groove 82; insertion rod 83; connection block 84; sliding rod 85; first spring 86; slider 87; dovetail block 91; limit rod 92; connecting rod 93; fixed rod 94; second spring 95; and pull block 96.

### DETAILED DESCRIPTION

Technical solutions in the embodiments of the present disclosure will be described clearly and completely below, in conjunction with the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should also be understood that the terms used in this specification of the present disclosure are only for the purpose of describing particular embodiments and are not intended to limit the present disclosure. As used in the specification and the appended claims of the present disclosure, the singular forms of “a”, “an” and “the” may be intended to include the plural forms, unless the context clearly indicates otherwise.

It should also be further understood that the term “and/or” used in the specification and the appended claims of the present disclosure refers to any combination of one or more of the relevantly listed items and all possible combinations, and includes these combinations.

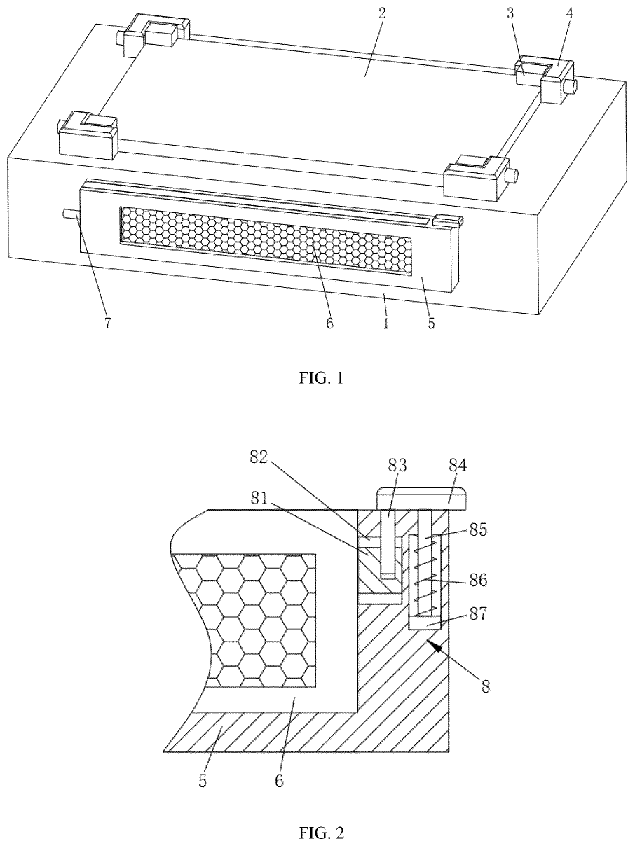

Referring to FIG. 1, a photovoltaic power generation device for facilitating heat dissipation includes a frame 1, which is in contact with a photovoltaic panel 2. The photovoltaic panel 2 is in contact with a pressure block 3 slidably connected to a mounting seat 4. The mounting seat 4 is slidably connected to the photovoltaic panel 2, the mounting seat 4 is fixedly connected to the frame 1, and the frame 1 is fixedly connected to a fixed seat 5. An interior the fixed seat 5 is slidably connected to a strainer 6, which is fixedly connected to a pull rod 7. The strainer 6 is provided with a connecting mechanism 8, and the photovoltaic panel 2 is provided with a mounting mechanism 9.

Referring to FIG. 1 and FIG. 2, the connecting mechanism 8 includes an insertion block 81, a groove 82, an insertion rod 83, a connection block 84, a sliding rod 85, a first spring 86, and a slider 87. The strainer 6 is fixedly connected to the insertion block 81, which is slidably connected to the fixed seat 5. The fixed seat 5 is provided with the groove 82, and an interior of the groove 82 is slidably connected to the insertion block 81. By designing the groove 82, the insertion block 81 may slide within the groove 82. An interior of the insertion block 81 is slidably connected to the insertion rod 83, the insertion rod 83 is slidably connected to the fixed seat 5, and the insertion rod 83 is fixedly connected to the connection block 84, which is in contact with the fixed seat 5. The connection block 84 is fixedly connected to the sliding rod 85, which is slidably connected to the fixed seat 5. The first spring 86 is arranged on an outer side of the sliding rod 85, where one end of the first spring 86 is fixedly connected to the slider 87, and other end of the first spring 86 is fixedly connected to the fixed seat 5. By designing the first spring 86, a force applied by the first spring 86 may act on the slider 87. The sliding rod 85 is fixedly connected to the slider 87, which is in contact with the fixed seat 5. By designing the connecting mechanism 8, it is convenient to disassemble the strainer 6.

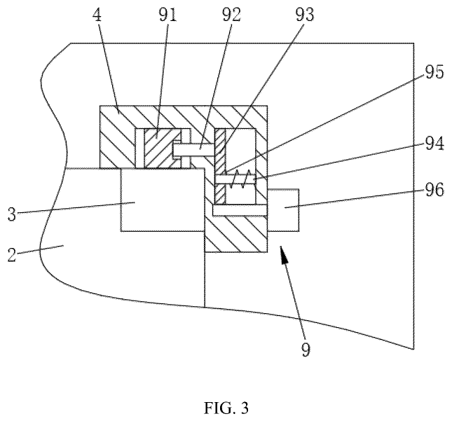

Referring to FIG. 1 and FIG. 3, the mounting mechanism 9 includes a dovetail block 91, a limit rod 92, a connecting rod 93, a fixed rod 94, a second spring 95, and a pull block 96. The pressure block 3 is fixedly connected to the dovetail block 91, which is slidably connected to the mounting seat 4. An interior of the dovetail block 91 is slidably connected to the limit rod 92, which is fixedly connected to the connecting rod 93. The limit rod 92 and the connecting rod 93 are both slidably connected to the mounting seat 4. An interior of the connecting rod 93 is slidably connected to the fixed rod 94, which is fixedly connected to the mounting seat 4. An outer side of the fixed rod 94 is provided with the second spring 95, where one end of the second spring 95 is fixedly connected to the connecting rod 93, and other end of the second spring 95 is fixedly connected to the mounting seat 4. By designing the second spring 95, the force applied by the second spring 95 may act on the connecting rod 93. The connecting rod 93 is fixedly connected to the pull block 96, which is slidably connected to the mounting seat 4. By designing the mounting mechanism 9, it is convenient to disassemble the photovoltaic panel 2.

Specific implementation processes of the present disclosure are as follows. When in use, by means of the strainer 6, dusts are filtered during air ventilation and heat dissipation inside the frame 1, thereby achieving the objective of internal dust prevention. When the strainer 6 needs to be disassembled, the connection block 84 is first pulled upwards, such that the connection block 84 drives the slider 87 and the sliding rod 85 to move, the slider 87 squeezes the first spring 86, and the connection block 84 drives the insertion rod 83 to move and separate from the insertion block 81. Next, the strainer 6 is moved horizontally to remove it from the fixed seat 5. In this way, the strainer 6 may be easily and quickly disassembled and then cleaned when there are many dust impurities attached to the surface of the strainer 6, to prevent blockage of the strainer 6 from adversely affecting internal heat dissipation efficiency of the frame 1. When it is needed to disassemble the photovoltaic panel 2, first the pull block 96 is pulled horizontally, such that the pull block 96 drives the connecting rod 93 to move horizontally. The connecting rod 93 slides along the fixed rod 94 and squeezes the second spring 95, and the connecting rod 93 drives the limit rod 92 to move horizontally and separate from the dovetail block 91. Next, the dovetail block 91 is removed from the mounting seat 4 to disassemble the pressure block 3. In this way, the pressure block 3 may be easily disassembled, making it convenient for maintenance and repair after the photovoltaic panel 2 is disassembled.

The preceding descriptions are merely specific embodiments of the present disclosure, but are not intended to limit the protection scope of the present disclosure. Any equivalent modifications or replacements easily conceivable to a person of skilled in the art within the technical scope disclosed in the present disclosure shall fall within the scope of protection of the present disclosure. Therefore, the protection scope of the present disclosure shall be subject to that of the claims.

What is claimed is:

1. A photovoltaic power generation device for facilitating heat dissipation, comprising a frame, wherein the frame is in contact with a photovoltaic panel, the photovoltaic panel is in contact with a pressure block slidably connected to a mounting seat, the mounting seat is slidably connected to the photovoltaic panel, the mounting seat is fixedly connected to the frame, the frame is fixedly connected to a fixed seat, an interior the fixed seat is slidably connected to a strainer, the strainer is fixedly connected to a pull rod, the strainer is provided with a connecting mechanism, and the photovoltaic panel is provided with a mounting mechanism.

2. The photovoltaic power generation device for facilitating heat dissipation according to claim 1, wherein the connecting mechanism comprises an insertion block, a groove, an insertion rod, a connection block, a sliding rod, a first spring, and a slider, the strainer is fixedly connected to the insertion block, the insertion block is slidably connected to the fixed seat, an interior of the insertion block is slidably connected to the insertion rod, the insertion rod is slidably connected to the fixed seat, the insertion rod is fixedly connected to the connection block, the connection block is in contact with the fixed seat, the connection block is fixedly connected to the sliding rod, the sliding rod is slidably connected to the fixed seat, the first spring is arranged on an outer side of the sliding rod, the sliding rod is fixedly connected to the slider, and the slider is in contact with the fixed seat.

3. The photovoltaic power generation device for facilitating heat dissipation according to claim 1, wherein the fixed seat is provided with a groove, and an interior of the groove is slidably connected to an insertion block.

4. The photovoltaic power generation device for facilitating heat dissipation according to claim 2, wherein one end of the first spring is fixedly connected to the slider, and other end of the first spring is fixedly connected to the fixed seat.

5. The photovoltaic power generation device for facilitating heat dissipation according to claim 1, wherein the mounting mechanism comprises a dovetail block, a limit rod, a connecting rod, a fixed rod, a second spring, and a pull block, the pressure block is fixedly connected to the dovetail block, the dovetail block is slidably connected to the mounting seat, an interior of the dovetail block is slidably connected to the limit rod, the limit rod is fixedly connected to the connecting rod, the limit rod and the connecting rod are both slidably connected to the mounting seat, an interior of the connecting rod is slidably connected to the fixed rod, the fixed rod is fixedly connected to the mounting seat, an outer side of the fixed rod is provided with the second spring, the connecting rod is fixedly connected to the pull block, and the pull block is slidably connected to the mounting seat.

6. The photovoltaic power generation device for facilitating heat dissipation according to claim 5, wherein one end of the second spring is fixedly connected to the connecting rod, and other end of the second spring is fixedly connected to the mounting seat.
